(19) United States
(12) Patent Application Publication
(10) Pub. No.: US 2014/0165016 A1
(43) Pub. Date: Jun. 12, 2014

(54) DATA LOADING METHOD, DESIGN SUPPORT DEVICE, AND RECORDING MEDIUM RECORDING DATA LOADING PROGRAM

(71) Applicant: FUJITSU LIMITED, Kawasaki-shi (JP)

(72) Inventor: Yasuo Amano, Nukata (JP)

(73) Assignee: FUJITSU LIMITED, Kawasaki-shi (JP)

(21) Appl. No.: 14/024,223

(22) Filed: Sep. 11, 2013

(30) Foreign Application Priority Data
Dec. 11, 2012 (JP) 2012-270149

(51) Int. Cl. G06F 17/50

(52) U.S. Cl. CPC G06F 17/5077
USPC 716/112

(57) ABSTRACT

A data loading method of loading part information of parts, includes; calculating, by a computer, a connection distance between the parts having a connection relationship based on design information including locations of first parts of the parts which have been placed by a design work or a connection relationship between the parts; calculating a distance judgment value based on a distance reference value and the connection distance; acquiring work information including work contents and a work location of the design work; identifying a part with the connection distance greater than or equal to the distance judgment value from second parts of the parts which have been placed and have not been wired when a placement work status based on the work information exceeds a placement reference value; and loading the part information of the identified part from a storage.

### CROSS-REFERENCE TO RELATED APPLICATION

This application is based upon and claims the benefit of priority of the prior Japanese Patent Application No. 2012-270149, filed on Dec. 11, 2012, the entire contents of which are incorporated herein by reference.

### FIELD

The embodiment discussed herein is related to a technique of loading data.

### BACKGROUND

In the design of a large-scale integrated (LSI) circuit, hierarchical design is adopted. In the hierarchical design, when a higher layer of a design object is designed, circuit data of component elements (hereinafter referred to as parts) of a lower layer is referred to in order to speed up data processing.

Related art is disclosed in Japanese Laid-open Patent Publication No. 2008-084011.

### SUMMARY

According to one aspect of the embodiment, a data loading method of loading part information of parts, includes; calculating, by a computer, a connection distance between the parts having a connection relationship based on design information including locations of first parts of the parts which have been placed by a design work or a connection relationship between the parts; calculating a distance judgment value based on a distance reference value and the connection distance; acquiring work information including work contents and a work location of the design work; identifying a part with the connection distance greater than or equal to the distance judgment value from second parts of the parts which have been placed and have not been wired when a placement work status based on the work information exceeds a placement reference value; and loading the part information of the identified part from a storage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an example of a data loading device;

FIG. 2A depicts an example of a design object;

FIGS. 2B to 2D depict an example of design information;

FIG. 3 depicts an example of part terminal location information;

FIG. 4 depicts an example of in-part wiring information;

FIGS. 5A to 5C depict an example of operation information;

FIG. 6 depicts an example of an information loading control table;

FIG. 7A depicts an example of placement and wiring;

FIG. 7B depicts an example of work information;

FIG. 8 depicts an example of a processing flow;

FIG. 9 depicts an example of prediction processing;

FIG. 10 depicts an example of an object to be loaded of in-part wiring information;

FIG. 11 depicts an example of a data loading device; and

FIG. 12 depicts an example of a hardware configuration of a data loading device.

### DESCRIPTION OF EMBODIMENT

For example, in design work by a CAD tool, after design information of a design object and part information (part terminal information, in-part wiring information) of all parts of a lower layer of the design object are loaded, placement or wiring is performed.

The size of LSI is increased, and the amount of data used for design is also increased. Even in hierarchical design, it takes a few hours to load part information (in-part wiring information) of all parts of a design object in a computer aided design (CAD) tool and it takes time to start the CAD tool, whereby design work efficiency may be reduced.

For example, priorities are set on the parts based on the information obtained by recording reference and updates of the parts in the design work, and the parts are loaded into a memory in order of priority.

At the start of the design work by the CAD tool (at the start of the CAD tool), part information which is not used depending on design work or part information which is not used immediately in design work may be loaded. This may lengthen a CAD tool starting time.

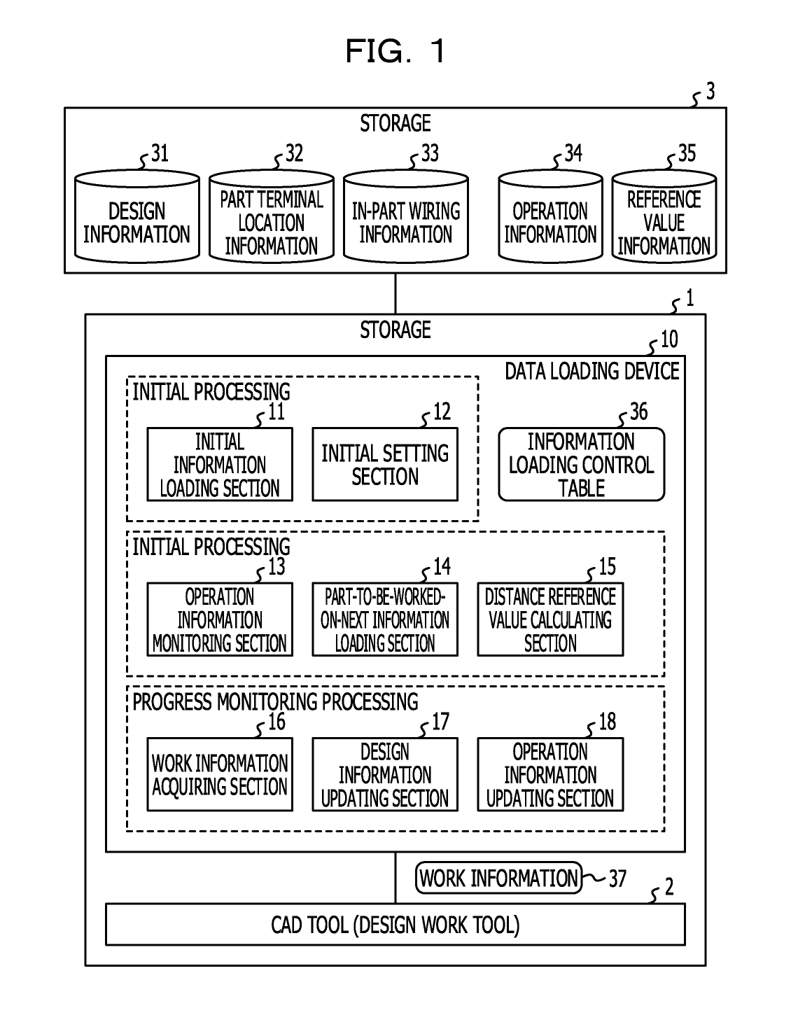

FIG. 1 depicts an example of a data loading device.

A CAD apparatus 1 includes a CAD tool 2, a storage 3, and a data loading device 10. The CAD tool 2 may be a design support device having the function of loading part information for design work.

The data loading device 10 selectively reads information to be used for design work from the design information that is stored in the storage 3 and used by the CAD tool 2 and stores the read information in a memory used by the CAD tool 2.

The design work performed by the CAD tool 2 may include placement work of the parts and wiring work between the parts. Since the longer the wiring distance, the more difficult the ensuring of wiring rules, the wiring work may be performed in such a way that wiring of the parts is performed in descending order of the distance between the parts.

The data loading device 10 focuses attention on such a feature of the wiring work and has the function of loading desired part information by predicting a part which is to be used next. For example, the data loading device 10 sets a distance reference value that becomes smaller in accordance with the progress of the design work in the CAD tool 2, predicts that a yet-to-be-wired part with a value greater than or equal to the calculated distance reference value from among the placed parts will be a next work object, and reads in-part wiring information 33 thereof from the storage 3.

In the hierarchical design, it is checked about whether the wiring inside the wired part is proper or not. When the size of the design object is increased, the number of parts of a lower layer is increased and the amount of data of the wiring information in part 33 to be loaded is also increased. However, since the in-part wiring information 33 is the information which may be a next work object, the data loading device 10 reads the in-part wiring information 33 while selecting the in-part wiring information 33 in order to shorten the starting time of the CAD tool 2 and make data loading more efficient.

For example, the data loading device 10 may reduce the amount of data to be read in one loading operation by sequentially reading only the part information of a part which is predicted to become a part for next work from the placed and yet-to-be-wired parts in accordance with the progress of the wiring work.

The data loading device 10 includes an initial information loading section 11, an initial setting section 12, an operation information monitoring section 13, a part-to-be-worked-on-next information loading section 14, a distance reference value calculating section 15, a work information acquiring section 16, a design information updating section 17, and an operation information updating section 18.

At the start of the design work in the CAD tool 2, the initial information loading section 11 reads design information 31, part terminal location information 32, operation information 34, and reference value information 35 from the storage 3 as information for initial processing.

The design information 31 may be information on the design contents processed by the CAD tool 2. The part terminal location information 32 may be information indicating the location (coordinates) of a terminal of each part.

The operation information 34 may be information on the operation in the design work of the CAD tool 2, and includes information indicating the number of parts forming the design object, the number of placed parts, the number of yet-to-be-wired parts, a connection relationship between the parts, or the like.

The reference value information 35 may be information indicating a judgment condition in the part-to-be-worked-on-next information loading section 14, and includes a placement work reference value PA for judging the progress of the placement work, a wiring work reference value PW for judging the progress of the wiring work, or a distance reference value PL for judging a part which is a next work object.

The initial setting section 12 creates, in a storage area, an information loading control table 36 indicating a loading status of the in-part wiring information 33 of the parts included in the design object based on the design information 31, and performs initialization of an initial loading completion flag SLF of the operation information 34, loading completion flags WLF of each of the parts which is provided in the information loading control table 36, and so forth.

The operation information monitoring section 13 monitors updates of the operation information 34.

The part-to-be-worked-on-next information loading section 14 predicts a part which will be a next work object from among the placed and yet-to-be-wired parts based on the design information 31 and the operation information 34, and loads, from the storage 3, the in-part wiring information 33 of the part that is predicted to be a next work object.

The in-part wiring information 33 may be information indicating the internal wiring lines of each part.

The distance reference value calculating section 15 calculates the distance reference value PL of the reference value information 35 based on the operation information 34.

The work information acquiring section 16 acquires work information 37 in which the operation performed by the user with the CAD tool 2 is recorded. The work information 37 indicates the operation contents and the operation position in the CAD tool 2. The operation contents may be instructions executed by the operation, such as placement, movement, or wiring, and the operation position may be information on the coordinates of a location in which the operation has been performed.

The design information updating section 17 updates the design information 31 based on the work information 37.

The operation information updating section 18 updates the operation information 34 based on the design information 31.

The CAD tool 2 may be software that supports the design work. The CAD tool 2 may be known software or may be any software.

The storage 3 may be an external storage that stores various data used by the CAD tool 2 and the data loading device 10. The storage 3 stores the design information 31, the part terminal location information 32, the in-part wiring information 33, the operation information 34, the reference value information 35, or the like.

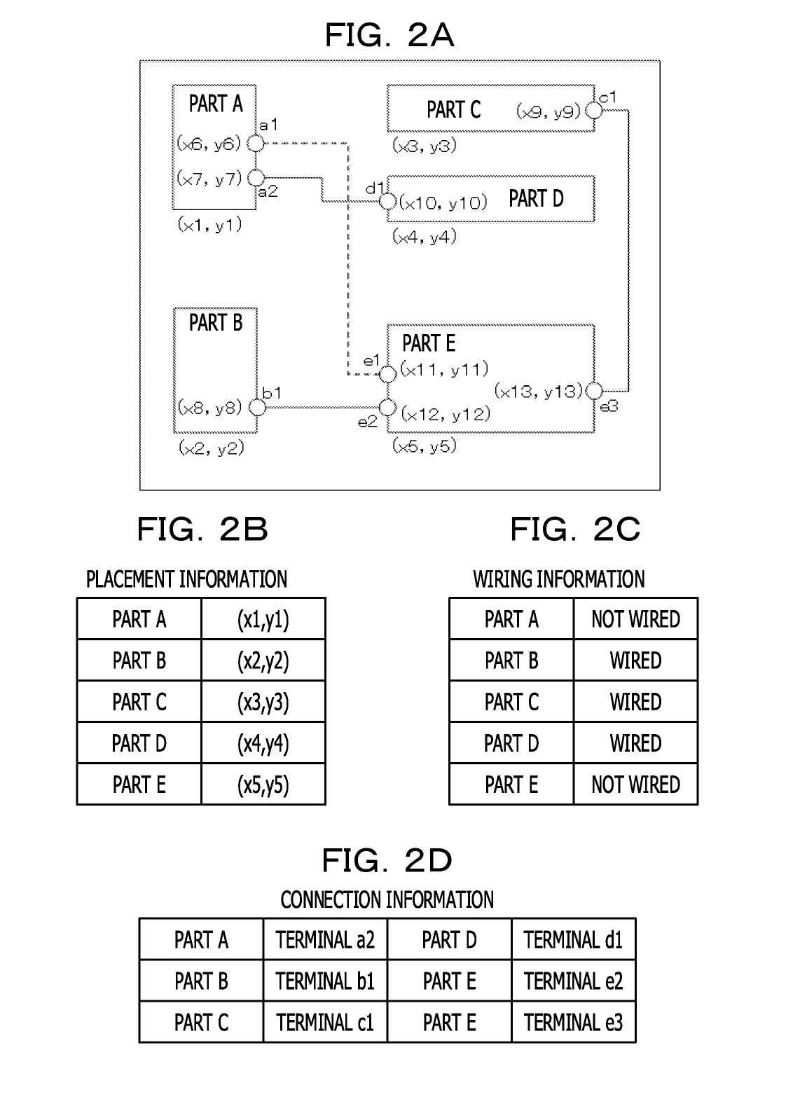

FIG. 2A depicts an example of a design object. FIGS. 2B to 2D depict an example of design information.

FIG. 2A depicts the design object for the CAD tool 2. The design object includes parts A, B, C, D, and E.

The design information 31 may be information indicating the placement, wiring, and so forth of the parts (the parts of the lower layer) including the parts of the design object (the parts of the higher layer).

FIG. 2B depicts the placement information of the design information 31. The placement information of the design information 31 includes the location (placement location) in which each part has been placed in the design work. The placement information depicted in FIG. 2B may correspond to the design object depicted in FIG. 2A. For example, the placement information indicates that the placement location of a “part A” is “coordinate values (x1, y1)”.

FIG. 2C depicts the wiring information of the design information 31. The wiring information of the design information 31 includes information indicating whether each part is wired or not wired. The wiring information depicted in FIG. 2C may correspond to the design object depicted in FIG. 2A. For example, the wiring information indicates that a terminal of the “part A” is “not wired (NOT WIRED)” and a terminal of a “part B” is “wired (WIRED)”.

FIG. 2D depicts the connection information of the design information. The connection information of the design information 31 includes terminals of the parts in each connection. The connection information depicted in FIG. 2D may correspond to the design object depicted in FIG. 2A. For example, the connection information of the design information indicates that a “terminal a2” of the “part A” and a “terminal d1” of a “part D” are coupled to each other and a “terminal b1” of the “part B” and a “terminal e2” of a “part E” are coupled to each other.

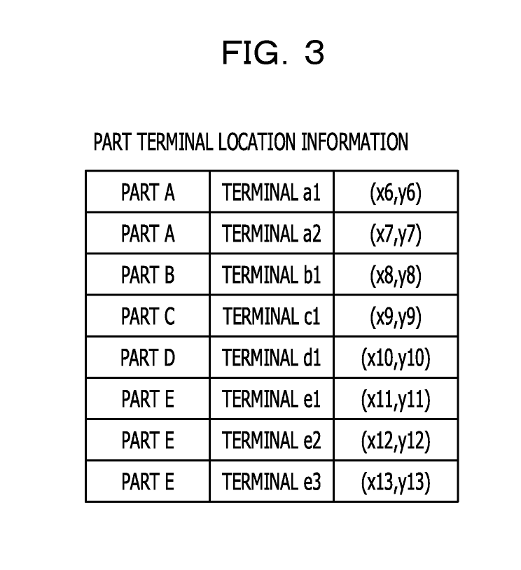

FIG. 3 depicts an example of part terminal location information.

The part terminal location information 32 includes location information (coordinates) of each terminal of each part. The part terminal location information 32 depicted in FIG. 3 may correspond to the design object depicted in FIG. 2A. The part terminal location information indicates that the location of a “terminal a1” of the “part A” is “coordinate values (x6, y6)”.

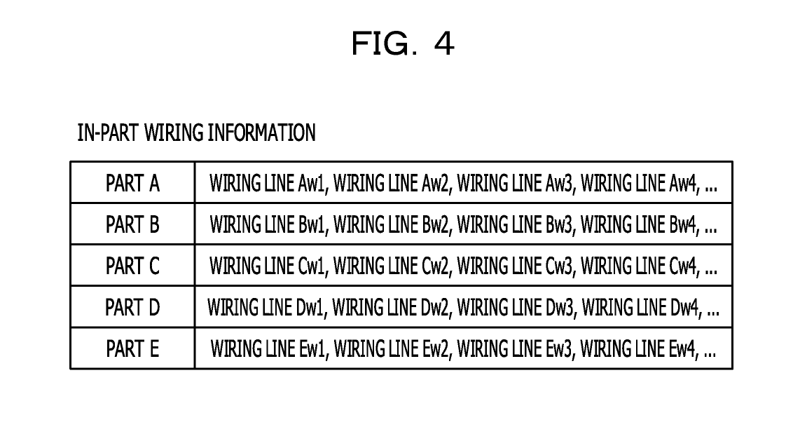

FIG. 4 depicts an example of in-part wiring information.

The in-part wiring information 33 may be information on the internal wiring lines of each part. For example, for the “part A”, the information of the internal wiring lines expressed as “a wiring line Aw1, a wiring line Aw1, a wiring line Aw3, a wiring line Aw4, . . . ” is recorded. The in-part wiring information 33 may be used for checking (error checking) the wiring between the parts and the wiring in the parts when wiring is performed between the parts of the higher layer.

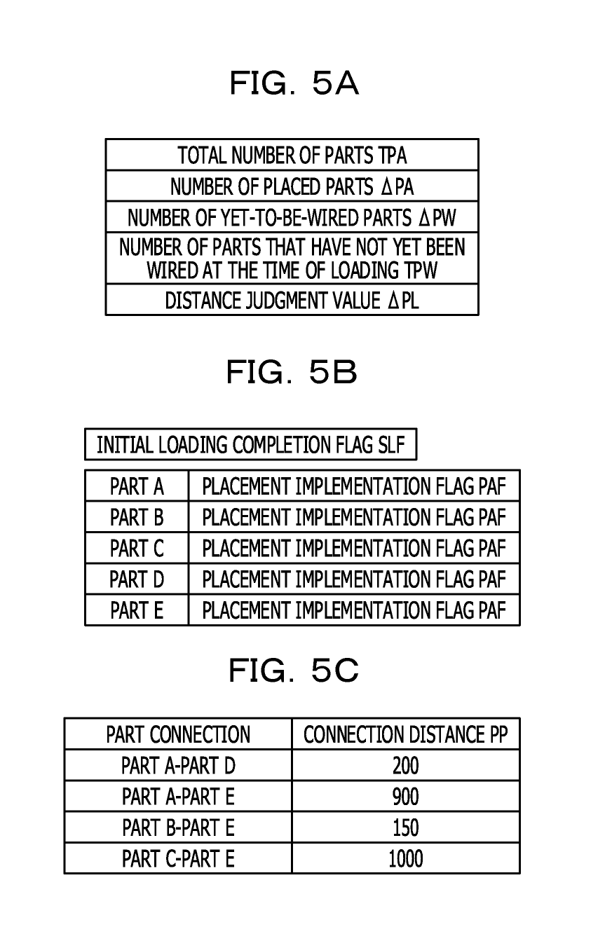

FIGS. 5A to 5C depict an example of operation information.

The operation information 34 includes various parameter values, flags, and inter-part connection information.

FIG. 5A depicts the parameters of the operation information 34. The parameters include, for example, the total number of parts TPA, the number of placed parts ΔPA, the number of yet-to-be-wired parts ΔPW, the number of parts that have not yet been wired at the time of loading TPW, or a distance judgment value ΔPL. The “total number of parts TPA” indicates the number of parts included in the design object. The “number of placed parts ΔPA” indicates the number of placed parts. The “number of yet-to-be-wired parts ΔPW” indicates the number of parts that have not yet been wired. The “number of parts that have not yet been wired at the time of loading TPW” indicates the number of parts that have not yet been wired at the beginning of data loading. The “distance judgment value ΔPL” indicates the distance which is used for judging a part on a next work object.

FIG. 5B depicts the flags of the operation information 34. The flags include, for example, the initial loading completion flag SLF and a placement implementation flag PAF for each part. The “initial loading completion flag SLF” may be a flag indicating whether or not the data loading device 10 has acquired the work information 37 after starting the work, and the “initial loading completion flag SLF” is set to be ON (the work information 37 acquired) or OFF (the work information 37 not acquired). The “placement implementation flag PAF” for each part may be a flag indicating whether or not the placement of the part has been performed, and the “placement implementation flag PAF” is set to be ON (the placement performed) or OFF (the placement not performed).

FIG. 5C depicts the inter-part connection information of the operation information 34. The inter-part connection information includes a connection distance PP between the parts, the connection distance PP being calculated based on the placement information of the design information 31 for each connection between the parts. For example, when the part A and the part D are placed as depicted in FIG. 2A, “200” may be obtained as the connection distance PP by calculation. When wiring between a part C and the part E is performed, “1000” may be obtained as the connection distance PP by calculation.

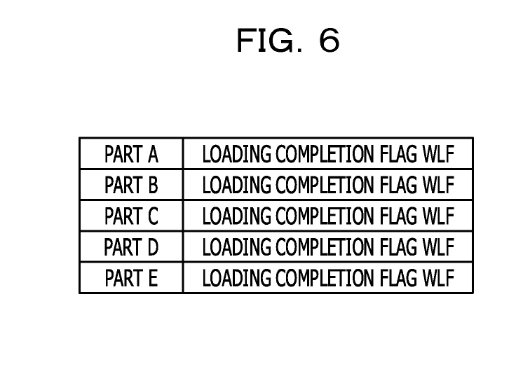

FIG. 6 depicts an example of an information loading control table. The “loading completion flag WLF”, for each part, of the information loading control table 36, the “loading completion flag WLF” may be a flag indicating whether or not the in-part wiring information 33 of the part has been loaded, and the “loading completion flag WLF” is set to be ON (loaded) or OFF (not loaded).

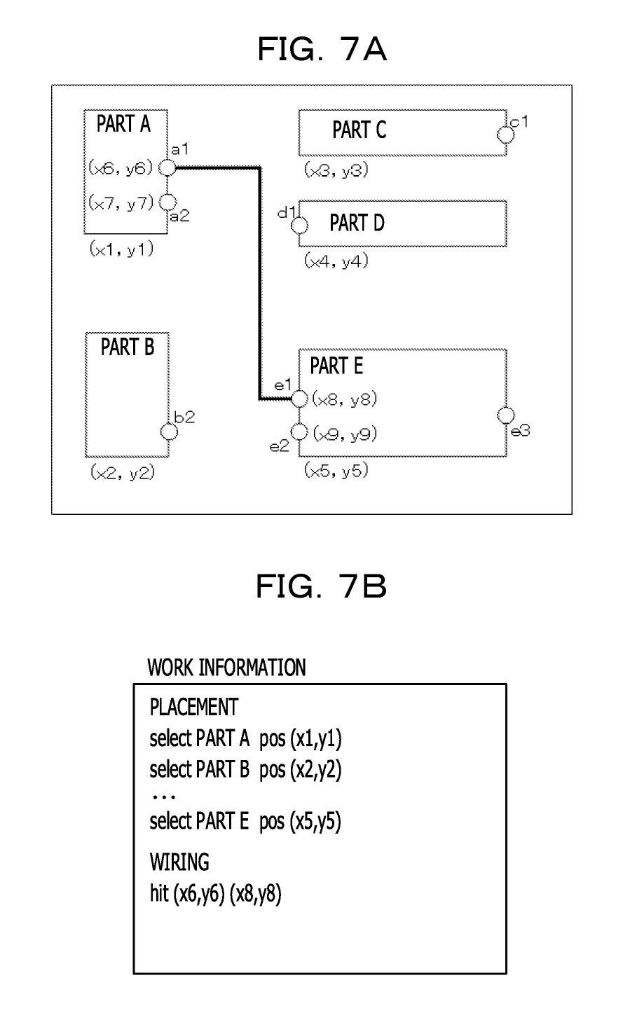

FIG. 7A depicts an example of a placement wiring. In FIG. 7A, the placement wiring may be performed by the CAD tool 2. As depicted in FIG. 7A, the parts A to E of the design object are placed, and wiring is performed to couple the terminal a1 of the part A and a terminal e1 of the part E.

FIG. 7B depicts an example of work information. The work information depicted in FIG. 7B may be the work information 37 that is acquired from the CAD tool 2 when the placement and wiring depicted in FIG. 7A are performed. The work information 37 indicates the placed parts and the locations thereof as the placement results and indicates the locations of the coupled terminals as the wiring results.

The following are examples of the processing of the data loading device 10.

(1) Since desired part information varies from design work to design work, the data loading device 10 judges the progress of the work based on the operation contents of the work information 37 and the placement information and the wiring information of the design information 31 and determines the in-part wiring information 33 to be loaded.

(2) To load the in-part wiring information 33 of the part that is being subjected to design work, the data loading device 10 acquires, from the placement information of the design information 31, a part present in the operation location of the work information 37 and loads the in-part wiring information 33 of the part.

(3) The data loading device 10 predicts a part which will be used next based on the connection distance between the parts having a connection relationship, the connection distance obtained based on the connection information of the design information 31, and the progress of the design work and loads the in-part wiring information of the part.

(4) When the design work is performed by the CAD tool 2 after the in-part wiring information is loaded, the data loading device 10 acquires the work information 37 indicating the operation contents of the CAD tool 2 and updates the design information 31 and the operation information 34.

(5) The data loading device 10 repeats the processing (3) above during the processing of the CAD tool 2 and loads desired part information.

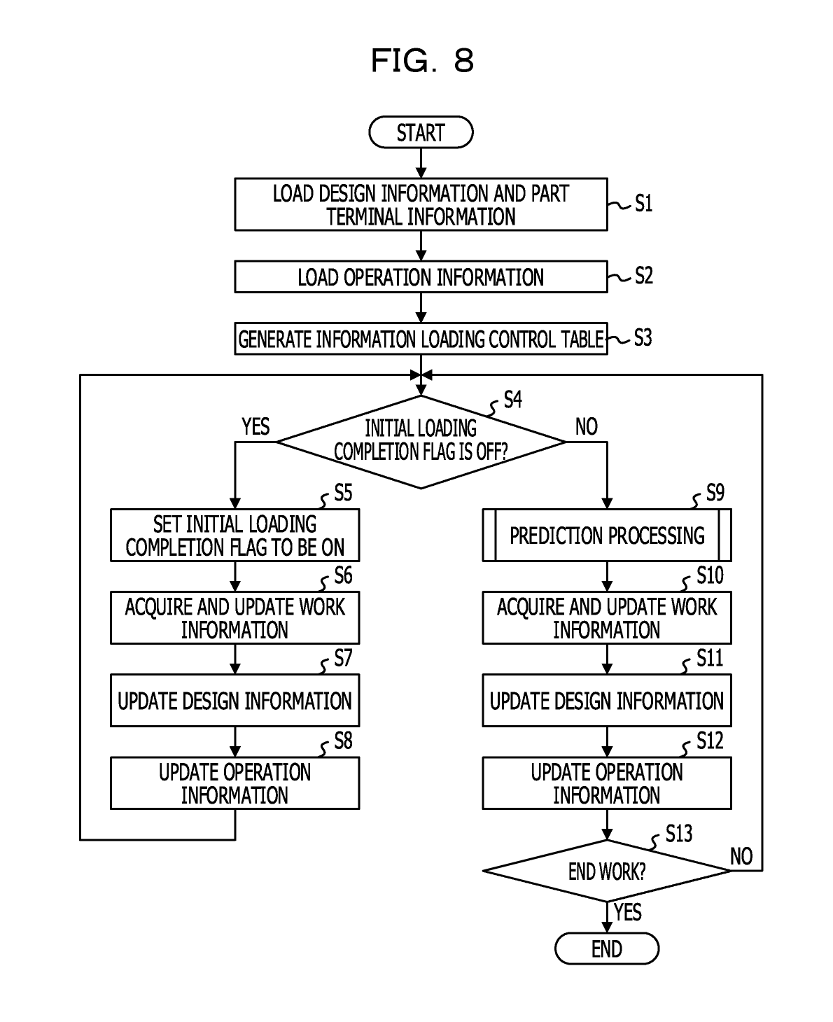

FIG. 8 depicts an example of a processing flow. The processing flow depicted in FIG. 8 may be processing performed by the data loading device 10 depicted in FIG. 1.

The initial information loading section 11 loads the design information 31 and the part terminal location information 32 from the storage 3 (operation S1) and loads the operation information 34 from the storage 3 (operation S2).

The initial setting section 12 sets the initial loading completion flag SLF of the operation information 34 to be “OFF”, and calculates the total number of parts TPA of the parts forming the design object based on the design information 31 and records the total number of parts TPA of the parts as the operation information 34. The initial setting section 12 generates the information loading control table 36 that records the loading completion flag WLF of each part based on the total number of parts TPA and sets the loading completion flag WLF to be “OFF” (operation S3).

The operation information monitoring section 13 judges whether the initial loading completion flag SLF is “OFF” (operation S4). If the initial loading completion flag SLF is “OFF” (Y in operation S4), the initial loading completion flag SLF is set to be “ON” (operation S5). The work information acquiring section 16 acquires, from the CAD tool 2, the work information 37 indicating the work contents based on the operation performed by the operator (operation S6), and the design information updating section 17 updates the design information 31 based on the work information 37 (operation S7). If the update is an update related to the placement of the design information 31, the operation information updating section 18 sets the placement implementation flag PAF of the part of the operation information 34 to be “ON” and increments the number of placed parts ΔPA by 1 (+1). If the update is an update related to the wiring of the design information 31, the operation information updating section 18 decrements the number of yet-to-be-wired parts ΔPW of the operation information 34 by 1 (−1) (operation S8).

If the initial loading completion flag SLF is not “OFF” (N in operation S4), prediction processing is performed, and the in-part wiring information 33 of a part which is a next work object is loaded (operation S9).

The work information acquiring section 16 acquires the work information 37 from the CAD tool 2 (operation S10). The design information updating section 17 updates the design information 31 based on the work information 37 (operation S11). The operation information updating section 18 updates the operation information 34 based on the design information 31 (operation S12).

It is judged whether the CAD tool 2 ends the work (operation S13). If the CAD tool 2 does not end the work (N in operation S13), the processing goes back to operation S4; if the CAD tool 2 ends the work (Y in operation S13), the processing is ended.

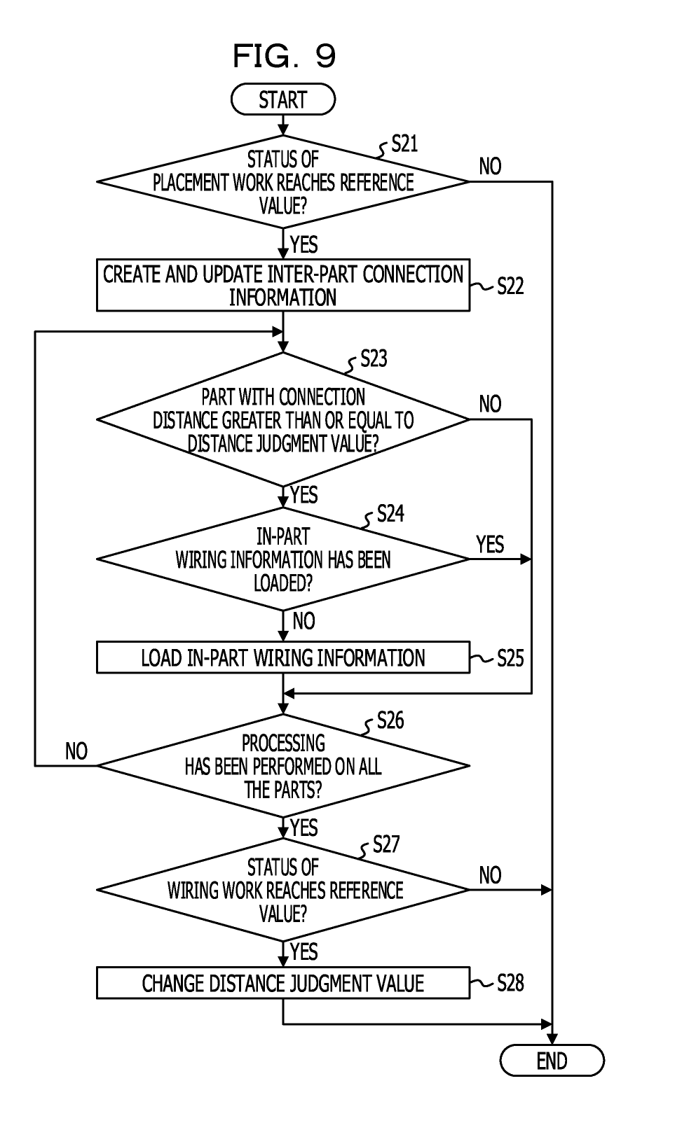

FIG. 9 depicts an example of a prediction processing. The prediction processing depicted in FIG. 9 may correspond to operation S9 depicted in FIG. 8.

If the placement implementation flag PAF of the operation information 34 is set to be “ON”, the part-to-be-worked-on-next information loading section 14 compares the status of the placement work with the placement work reference value PA (operation S21). Based on the number of placed parts ΔPA and the total number of parts TPA of the operation information, the status of the placement work is obtained as follows.

“The status of the placement work=the number of placed parts ΔPA÷the total number of parts TPA”

If the status of the placement work reaches the placement work reference value PA (Y in operation S21), the processing proceeds to operation S22; if the status of the placement work does not reach the placement work reference value PA (N in operation S21), the prediction processing is ended.

The part-to-be-worked-on-next information loading section 14 extracts the connection relationship between the placed parts based on the design information 31, calculates the connection distance PP for each connection relationship between the parts, and creates and updates the inter-part connection information of the operation information 34 (operation S22).

The part-to-be-worked-on-next information loading section 14 sets the placement implementation flag PAF of the operation information 34 to be “OFF”, and, based on the connection distance PP of the inter-part connection information and the distance reference value PL, calculates the distance judgment value ΔPL as follows.

“The distance judgment value ΔPL=the greatest connection distance PP between the yet-to-be-wired parts×the distance reference value PL”

The part-to-be-worked-on-next information loading section 14 compares the connection distance PP of the inter-part connection information with the distance judgment value ΔPL (operation S23). If the connection distance PP of the part is greater than or equal to the distance judgment value ΔPL (Y in operation S23), the part-to-be-worked-on-next information loading section 14 judges whether the in-part wiring information 33 has been loaded by referring to the information loading control table 36 (operation S24). If the loading completion flag WLF of the information loading control table 36 is not “ON” (N in operation S24), the part-to-be-worked-on-next information loading section 14 loads the in-part wiring information of the part from the storage 3, increments the number of yet-to-be-wired parts ΔPW of the operation information 34 by 1 (+1), and sets the loading completion flag WLF of the part of the information loading control table 36 to be “ON” (operation S25). If the connection distance PP of the part is smaller than the distance judgment value ΔPL (N in operation S23), operations S24 and S25 are skipped.

If the processing has not been performed on all the placed parts of the inter-part connection information (N in operation S26), the processing goes back to operation S23; if the processing has been performed on all the parts (Y in operation S26), the status of the wiring work and the wiring work reference value PW are compared with each other (operation S27). Based on the number of parts that have not yet been wired at the time of loading TPW and the number of yet-to-be-wired parts ΔPW of the operation information 34, the status of the wiring work is obtained as follows.

“The status of the wiring work=(the number of parts that have not yet been wired at the time of loading TPW−the number of yet-to-be-wired parts ΔPW)÷the number of parts that have not yet been wired at the time of loading TPW”

If the status of the wiring work reaches the wiring work reference value PW (Y in operation S27), the processing proceeds to operation S29; if the status of the wiring work does not reach the wiring work reference value PW (N in operation S27), the prediction processing is ended.

Based on the distance reference value PL, the distance reference value calculating section 15 calculates the distance judgment value ΔPL as follows and sets the calculated distance judgment value ΔPL in the operation information 34 (operation S28).

“The distance judgment value ΔPL=the distance judgment value ΔPL×the distance reference value PL”

By this calculation, a part with a smaller connection distance may be judged to be a work object when a work object is judged by the status of the wiring work based on the next work information 37.

For example, the inter-part connection information of the operation information 34 of the data loading device 10 may be the information depicted in FIG. 5A.

If the placement work of the part is completed with its status indicated as greater than or equal to the placement work reference value PA (for example, 90%), based on the inter-part connection information of the operation information 34 and the distance reference value PL (for example, 50%), the part-to-be-worked-on-next information loading section 14 calculates the distance judgment value ΔPL as follows: “the greatest connection distance PP×the distance reference value PL=1000×50%=500”.

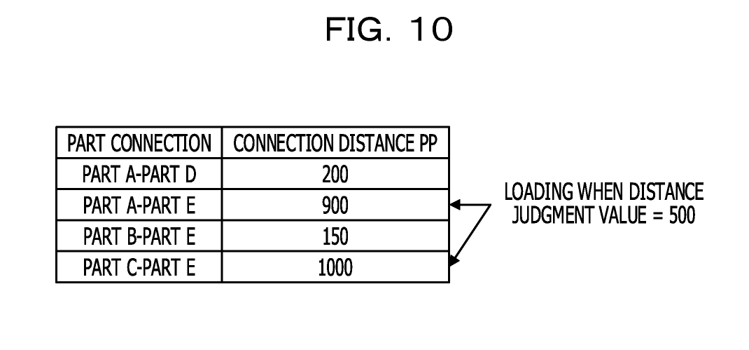

FIG. 10 depicts an example of an object to be loaded of in-part wiring information. As depicted in FIG. 10, the part-to-be-worked-on-next information loading section 14 regards the part A, the part C, and the part E whose connection distances PP of the inter-part connection information are greater than or equal to the distance judgment value ΔPL (500) as next work objects and loads the in-part wiring information 33 of these parts from the storage 3. Since the distance judgment value ΔPL is re-calculated in accordance with the status of the wiring work at each loading of the in-part wiring information 33 and becomes a smaller value, the part-to-be-worked-on-next information loading section 14 loads the in-part wiring information 33 of a part with a smaller connection distance PP between the parts as the wiring work progresses.

In the data loading device 10, the in-part wiring information 33 of a part with a greater distance is first loaded and then the in-part wiring information 33 of a part with a smaller connection distance PP is loaded. Partial loading of data corresponding to the design work in which the wiring work is performed from the parts with the greatest distance therebetween is performed.

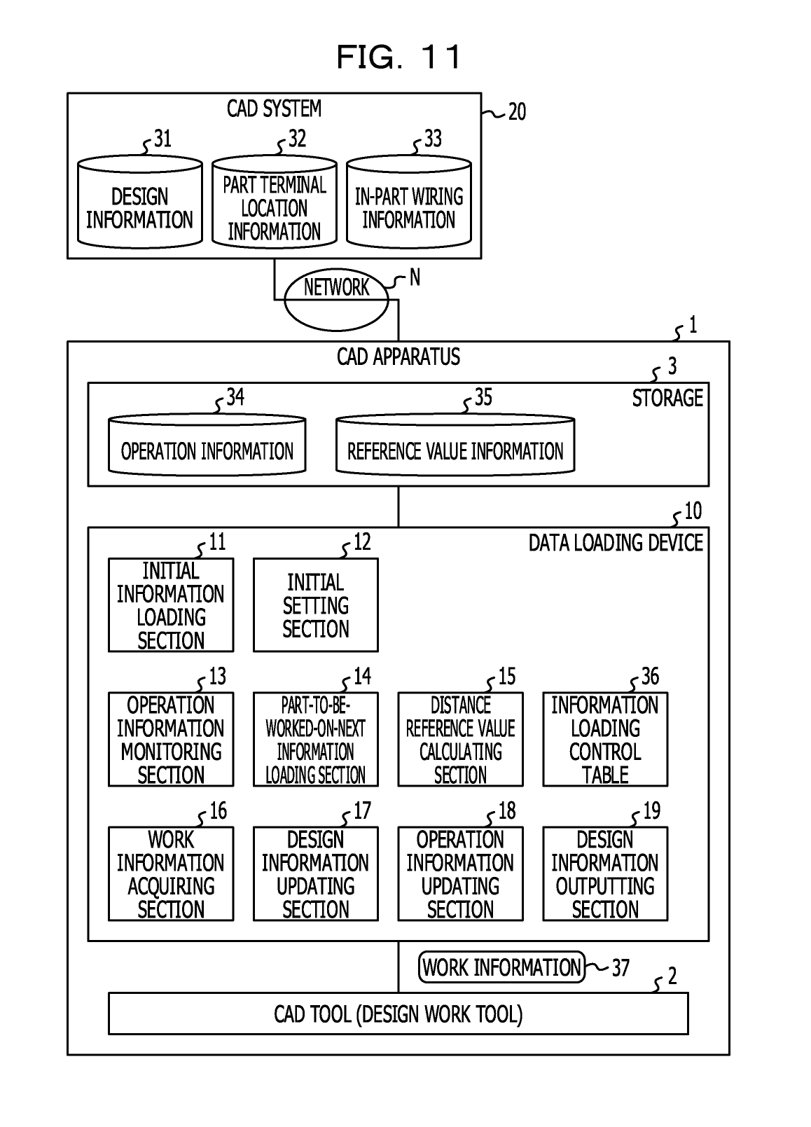

FIG. 11 depicts an example of a data loading device. In FIG. 11, the CAD tool 2 may be a client's-side program corresponding to a CAD system 20. The design information 31, the part terminal location information 32, and the in-part wiring information 33 are stored or managed in the CAD system 20. In this case, the CAD apparatus 1 may be an apparatus that is able to perform data communication with the CAD system 20 via a network N.

The functional configuration of the data loading device 10 may be substantially the same as the functional configuration depicted in FIG. 1 or similar to the functional configuration depicted in FIG. 1 and may include a design information outputting section 19.

The initial information loading section 11 and the part-to-be-worked-on-next information loading section 14 of the data loading device 10 acquire the design information 31, the part terminal location information 32, and the in-part wiring information 33 from the CAD system 20 via the network N and store the acquired information in the storage 3. During or at the end of the design work, the design information outputting section 19 transmits the updated design information 31 stored in the storage 3 to the CAD system 20.

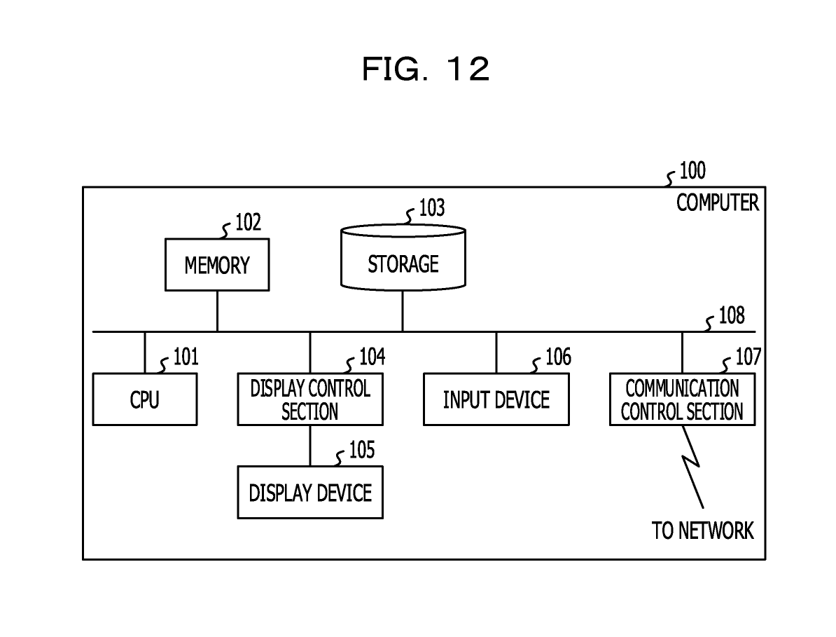

FIG. 12 depicts an example of a hardware configuration of a data loading device. The CAD apparatus 1 including the data loading device 10 may be dedicated hardware provided with the processing sections depicted in FIG. 1. The CAD apparatus 1 may correspond to a computer 100 depicted in FIG. 12, the computer 100 in which a CPU 101, a memory 102, a storage (hard disk) 103, a display control section 104, a display device (display) 105, an input device (keyboard) 106, and a communication control section 107 are coupled to one another by a bus 108.

Each processing section of the data loading device 10 may be implemented as a program that is executable by the computer 100. For example, a program that implements the functions of the processing sections of the data loading device 10 depicted in FIG. 1 is executed by the computer 100. An execution program that makes the computer execute the functions of the initial information loading section 11, the initial setting section 12, the operation information monitoring section 13, the part-to-be-worked-on-next information loading section 14, the distance reference value calculating section 15, the work information acquiring section 16, the design information updating section 17, and the operation information updating section 18, which are depicted in FIG. 1, is loaded into the memory 102 of the computer 100 and executed by the CPU 101, whereby the data loading device 10 works.

The execution program may be stored not only in recording media such as a CD-ROM, a CD-RW, a DVD-R, a DVD-RAM, a DVD-RW, and a flexible disk, but also in other storages and computers that are provided at the end of a communication line.

The elements included in the data loading device 10 may be combined arbitrarily.

As described above, with the data loading device 10, information on a part which is used next is selectively loaded. As a result, in circuit design of a large-scale integrated (LSI) circuit including many parts, the starting time of the CAD tool 2 is reduced, which may improve the time efficiency of the design work.

For example, data loading performed by the data loading device 10 allows the CAD tool 2 to be started in a few minutes, which may reduce the starting time.

With the data loading device 10, since the in-part wiring information 33 of a yet-to-be-wired part with a greater connection distance, the yet-to-be-wired part of the parts that have not yet been wired, is sequentially loaded in accordance with the status of the placement work even during the design work, the data loading efficiency may be improved.

Since the processing of the data loading device 10 is executed separately from the processing of the CAD tool 2, the processing of the data loading device 10 may load desired information without hindering the processing of the CAD tool 2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A data loading method of loading part information of parts, comprising;
calculating, by a computer, a connection distance between the parts having a connection relationship based on design information including locations of first parts of the parts which have been placed by a design work or a connection relationship between the parts;
calculating a distance judgment value based on a distance reference value and the connection distance;
acquiring work information including work contents and a work location of the design work;
identifying a part with the connection distance greater than or equal to the distance judgment value from second parts of the parts which have been placed and have not been wired when a placement work status based on the work information exceeds a placement reference value; and
loading the part information of the identified part from a storage.

2. The data loading method according to claim 1,
wherein the distance judgment value is calculated based on a greatest connection distance between third parts of the parts which have not been wired.

3. The data loading method according to claim 1,
wherein the placement work status is based on a ratio between a number of the first parts of the work information and a number of the parts.

4. The data loading method according to claim 1,
wherein the distance judgment value is reduced when a wiring work status exceeds a wiring reference value at a time of loading of the part information of the identified part.

5. The data loading method according to claim 4,
wherein the wiring work status is based on a ratio between a number of third parts of the parts that have not been wired and a number of the second parts.

6. A design support device that loads part information of parts, comprising:
a storage configured to store design information including locations of first parts of the parts which have been placed by design work and a connection relationship between the parts and part information including internal wiring lines of the parts;
a distance reference value calculating section configured to calculate a connection distance between parts having a connection relationship based on the design information and calculate a distance judgment value based on a distance reference value and the connection distance;
a work information acquiring section configured to acquire work information including work contents and a work location of the design work; and
an information loading section configured to identify a part with the connection distance greater than or equal to the distance judgment value from second parts of the parts which have been placed and have not been wired when a placement work status based on the work information exceeds a placement reference value and load the part information of the identified part from the storage.

7. A recording medium that records a data loading program executed by a computer that loads part information of the parts, the data loading program causing the computer to:
calculate a connection distance between the parts having a connection relationship based on design information including locations of first parts of the parts which have been placed by a design work or a connection relationship between the parts;
calculate a distance judgment value based on a distance reference value and the connection distance;
acquire work information including work contents and a work location of the design work;
identify a part with the connection distance greater than or equal to the distance judgment value from second parts of the parts which have been placed and have not been wired when a placement work status based on the work information exceeds a placement reference value; and
load the part information of the identified part from a storage.
